(19) United States
(12) Patent Application Publication
(10) Pub. No.: US 2015/0334502 A1
(43) Pub. Date: Nov. 19, 2015

(54) SOUND SIGNAL DESCRIPTION METHOD, SOUND SIGNAL PRODUCTION EQUIPMENT, AND SOUND SIGNAL REPRODUCTION EQUIPMENT

(71) Applicants: NIPPON HOSO KYOKAI, Shibuya-ku, Tokyo (JP); ELECTRONICS AND TELECOMMUNICATIONS RESEARCH INSTITUTE, Daejeon (KR)

(72) Inventors: Kaoru WATANABE, Setagaya-ku, Tokyo (JP); Satoshi OODE, Setagaya-ku, Tokyo (JP); Ikuko SAWAYA, Setagaya-ku, Tokyo (JP); Jae-hyoun YOO, Daejeon (KR); Taejin LEE, Daejeon (KR); Kyeongok KANG, Daejeon (KR)

(73) Assignees: NIPPON HOSO KYOKAI, Shibuya-ku, Tokyo (JP); ELECTRONICS AND TELECOMMUNICATIONS RESEARCH INSTITUTE, Daejeon (KR)

(21) Appl. No.: 14/652,907

(22) PCT Filed: Dec. 16, 2013
(86) PCT No.: PCT/JP2013/007390

§ 371 Date: Jun. 17, 2015

(30) Foreign Application Priority Data
Jan. 23, 2013 (JP) 2013-010544

(51) Int. Cl. H04S 7/00

(52) U.S. Cl. CPC H04S 7/30

(57) ABSTRACT

Provided is a sound signal description method corresponding to a format of “sound signals to compose a multi-layered sound field”, as well as a sound signal production equipment and a sound signal reception equipment which correspond to the sound signal description method.

The sound signal description method for describing the multi-layered sound field includes the number of sound field layers of the multi-layered sound field, a type of each sound field layer of the multi-layered sound field, and language information.

### TECHNICAL FIELD

This disclosure relates to a sound signal description method, a sound signal production equipment, and a sound signal reproduction equipment, all of which are capable of representing information of sound signals with use of metadata for sound reproduction through multichannel speakers.

### BACKGROUND

Various sound systems, such as a 2 channel sound system, a 5.1 channel sound system, and “3-dimensional multichannel stereophonic sound systems” beyond the 5.1 channel sound system, are used for program production. Describing the various sound systems using a common description format provides flexibility to the sound systems, which allows the systems to be applied to next-generation sound systems across various sound application scenarios. ITU-R, which is an international standardization body associated with broadcasting including sound, has defined requirements for an advanced multichannel sound system as ITU-R Recommendation. (Refer to Non Patent Literature 1.)

### CITATION LIST

### Non-Patent Literature

NPL 1: “Performance requirements for an advanced multichannel stereophonic sound system for use with or without accompanying picture”, Recommendation ITU-R BS.1909.

As the common description format for describing the various sound systems, an advanced study has been conducted on “sound signals to compose a single-layered sound field.” However, in some cases of sound program production, the format of “sound signals to compose a multi-layered sound field” can be used so as to facilitate rendering, conversion, and switching of received sound signals according to a receiver's environment or demand of program exchange or a home reproduction. For example, the receiver of program exchange or the home sometimes does not employ the same size image display as in the program production, and according to such a video reproduction environment of the receiver, the sound signal needs to be converted. Furthermore, it is sometimes required a language switching for program reproduction and, a reproduction position relocation of a narration signal according to needs of the receiver. Conventionally, however, the study has not been conducted on the description method for the “sound signals to compose a multi-layered sound field.”

It could therefore be helpful to provide a sound signal description method corresponding to the format of the “sound signals to compose a multi-layered sound field”, as well as a sound signal production equipment and a sound signal reproduction equipment which correspond to the sound signal description method.

### SUMMARY

One of the disclosed aspects therefore provides a sound signal description method for describing a multi-layered sound field, comprising: the number of sound field layers of the multi-layered sound field; a type of each sound field layer of the multi-layered sound field; and language information.

It is preferable that the type of each sound field layer of the multi-layered sound field indicates the sound elements of the program, such as one of international sound, which consists of all the sound program elements except for the commentary/dialogue elements, and one of commentary/dialogue sound with particular language.

Furthermore, another one of the disclosed aspects provides a sound signal description method for describing a multi-layered sound field, comprising: the number of sound field layers of the multi-layered sound field; and a video link identifier indicating, for each sound field layer of the multi-layered sound field, whether the sound field layer is linked to video.

Moreover, yet another one of the disclosed aspects provides a sound signal production equipment that produces a sound signal according to a sound signal description method for describing a multi-layered sound field, comprising: a metadata addition unit that produces metadata including the number of sound field layers of the multi-layered sound field, a type of each sound field layer of the multi-layered sound field, and language information; a coding unit that produces the sound signal according to the sound signal description method based on an input sound signal and the metadata; and a multiplexer that multiplexes the produced sound signal into a bit stream.

Moreover, yet another one of the disclosed aspects provides a sound signal reproduction equipment that reproduces a sound signal according to a sound signal description method for describing a multi-layered sound field, comprising: an environment information input unit that inputs reproduction environment information and user demand information; and a rendering reproduction unit that converts the sound signal according to the number of sound field layers of the multi-layered sound field, a type of each sound field layer of the multi-layered sound field, and language information included in the sound signal and according to the reproduction environment information and user demand information, and reproduces the converted sound signal.

The type of each sound field layer of the multi-layered sound field indicates which one of international sound and a particular language the sound field layer comprises, the international sound being used irrespective of language, and the particular language being switched by the environment information input unit. The rendering reproduction unit preferably adds the sound signal of the particular language to the international sound and reproduces added sound.

Moreover, yet another one of the disclosed aspects provides a sound signal production equipment that produces a sound signal according to a sound signal description method for describing a multi-layered sound field, comprising: a metadata addition unit that produces metadata including the number of sound field layers of the multi-layered sound field and a video link identifier indicating, for each sound field layer of the multi-layered sound field, whether the sound field layer is linked to video; a coding unit that produces the sound signal according to the sound signal description method based on an input sound signal and the metadata; and a multiplexer that multiplexes the produced sound signal into a bit stream.

Moreover, yet another one of the disclosed aspects provides a sound signal reproduction equipment that reproduces a sound signal according to a sound signal description method for describing a multi-layered sound field, comprising: an environment information input unit that inputs reproduction environment information and user demand information; and a rendering reproduction unit that converts the sound signal according to the number of sound field layers of the multi-layered sound field and a video link identifier included in the sound signal and according to the reproduction environment information and user demand information. The video link identifier indicating, for each sound field layer of the multi-layered sound field, whether the sound field layer is linked to video.

When the video link identifier indicates that the sound field layer is linked to video, the rendering reproduction unit preferably renders the sound signal of the sound field layer based on video display information input by the environment information input unit.

The disclosed sound signal description method, the disclosed sound signal production equipment, and the disclosed sound signal reproduction equipment-make it possible to describe the “sound signals to compose a multi-layered sound field” and to produce and reproduce a sound program using the sound signals.

### BRIEF DESCRIPTION OF THE DRAWINGS

In the accompanying drawings:

FIG. 1 shows an exemplary structure of an “Extended sound field descriptor” according to one of the disclosed embodiments;

FIG. 2 shows a block diagram of a sound signal production equipment according to one of the disclosed embodiments;

FIG. 3 shows a block diagram of a sound signal reproduction equipment according to one of the disclosed embodiments;

FIG. 4 is a conceptual diagram of a multi-layered sound field in connection with narration language switching;

FIG. 5 shows a difference in display size between a program production environment and a reproduction environment;

FIG. 6 is a conceptual diagram of the multi-layered sound field associated with linked/unlinked video and sound; and

FIG. 7 shows an exemplary structure of a “Basic sound field descriptor”.

### DETAILED DESCRIPTION

Embodiments of our methods and equipment will be described in detail below with reference to the drawings.

We extend a description method (referred to below as a “Basic sound field descriptor”) for describing “sound signals to compose a single-layered sound field” to the description method (referred to below as an “Extended sound field descriptor”) for describing a “sound signals to compose a multi-layered sound field.” Regarding the Basic sound field descriptor, we filed a Korean Patent Application (10-2012-0112984), and the Basic sound field descriptor is reviewed below for understanding of the disclosure.

In order to describe multichannel sound signals to compose a single-layered sound field, it is necessary to describe which channel corresponds to the reproduction position. The described information is called descriptor, which is described as metadata in a header of a corresponding multichannel sound signal or in the headers on each sound channel constituting the multichannel.

Table 1 illustrates terms and definitions of the Basic sound field descriptor. The Basic sound field descriptor is employed for production and exchange of complete mix programs (i.e. programs including all sound required for reproduction) with multichannel sound, for example.

TABLE 1
Terms

| | |
|---|---|
| Sound Channel | Distinct collection of sequenced sound |
| | samples that are intended for delivery |
| | to a single loudspeaker or other |
| | reproduction device. |
| | Composed of individual sound channel |
| | positions (directions) to be |
| | reproduced. Includes Type of Sound |
| | Channel Component Object |
| | (reproduction frequency level |
| | characteristics and spatial directivity |
| | characteristics). Includes an |
| | object-based signal. |
| Type of Sound channel | Type of individual sound channel |
| component Object | signal components (Nominal |
| | frequency-level characteristics and |
| | spatial directivity characteristics). |
| Sound-field | Defined arrangement or configuration |
| configuration | of loudspeakers that conveys the |
| | intended Sound-field. (A group of |
| | sound channels that are intended to be |
| | reproduced simultaneously through a |
| | defined Sound-field configuration). |
| Sound-field | The acoustical space within which the |
| | intended sound image is created, |
| | which are created by simultaneously |
| | reproducing sound channels described |
| | by the Sound field configuration. |
| Sound Essence | The sound resources that make up a |
| | sound program of television and |
| | sound-only program |

The Sound Essence descriptor includes a descriptor of a program, a descriptor (name) of the Sound-field, and other relevant descriptors.

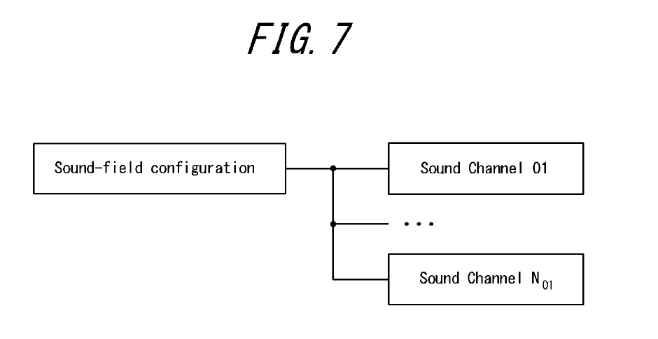

As shown in FIG. 7, the Sound-field is described by the Sound-field configuration with a hierarchical structure.

The Sound Channel descriptor includes the Channel label descriptor and/or Channel Position descriptor.

The following describes the descriptors in the Basic sound field descriptor. Note that some of the descriptors overlap with each other in anticipation of different program exchange scenarios. However, a program producer or the like is able to appropriately choose necessary descriptors for each program exchange scenario.

The Basic sound field descriptor includes (A) Sound Essence descriptors, (B) Sound-field configuration descriptors, and (C) Sound Channel descriptors.

Table 2 shows (A) Sound Essence descriptors in the Basic sound field descriptor.

TABLE 2

| Name of | Subject of | |
|---|---|---|
| Descriptor | Description | Example(s) |
| Program Name | Program title | Program Title |
| Type of Sound | Name of Type and Content of | Complete mix |
| essence | Sound essence | |
| (Sound-field) | | |
| Name of sound-field | Name of defined multichannel | 22.2 ch, 10.2 ch, |
| configuration | sound arrangement | etc. |
| Loudness value | Loudness value | |

Table 3 shows (B) Sound-field configuration descriptors in the Basic sound field descriptor.

TABLE 3
(B) Sound-field configuration descriptors -
multichannel arrangement data

| Name of | Subject of | |
|---|---|---|
| Descriptor | Description | Example(s) |
| Name of | Name of defined | 22.2 ch, 10.2 ch, etc. |
| Sound-field | multichannel sound | |
| configuration | arrangement | |
| The number of | The total number | 24 channels, 12 |
| channels | of channel | channels |
| Multichannel | Numbers of horizontal | Middle: 10, front: 5, side: 2, |
| sound | and/or | back: 3, top: 9, front: 3, |
| arrangement | vertical channels | side: 3, back: 3, |
| description | | bottom: 3, front: 3, side: |
| | | 0, back: 0, LFE: 2 |
| List of channel | Mapping of channel | 1: Mid_L, 2: Mid_R, |
| allocation | allocation | 3: Mid_C, 4: LFE, |
| | | 5: Mid_LS, 6: Mid_RS |
| Down-mixing | Coefficients in | |
| coefficient | order to down | |
| | mix to conventional | |
| | Sound-field (5.1 ch, | |
| | 2 ch or 1 ch) | |

Table 4 shows (C) Sound Channel descriptors in the Basic sound field descriptor.

TABLE 4
(C) Sound Channel descriptors

| Name of | Subject of | |
|---|---|---|
| Descriptor | Description | Example(s) |
| Indicator of Sound | Indicator of Channel | 11: Channel label data |
| Channel descriptor | label data and Channel | [On]/Channel position |
| | position data | data [On] |

Table 5 shows C.1 Channel label descriptors, which are descriptors of the Channel label data included in the Sound Channel descriptors.

TABLE 5
C.1 Channel label descriptors

| Name of | Subject of | |
|---|---|---|
| Descriptor | Description | Example(s) |
| Allocation | Allocation | 1: first channel, 2: second |
| number | number | channel, etc |
| Channel label | Horizontal | C: Center of screen, L: Left side |
| (A label to | Channel label | of screen, Lc: Inner side on the |
| indicate the | | left of the screen, Lw: Outer |
| intended channel | | side on the left of screen |
| for sound | Vertical | Mid: Middle layer, Tp: Top |
| reproduction) | Channel label | layer (above the listener's ear |
| | | height), Bt: Bottom layer |
| | | (under the listener's ear height) |
| | Distance | Near, Far |
| | Channel label | |
| | Object | Vocal, Piano, Drum, etc |
| | Channel label | |
| Type(Character- | Nominal | Full: general channel, LFE: Low |
| istics) of channel | frequency | frequency effect channel |
| component object | Range | (Include channel label or |
| | | other?) |
| | Type of | /Direct/Diffuse/Surround |
| | channel | (Include channel label or |
| | component | other?) |
| | directivity | |
| | Moving | Information for moving |
| | Information | objects: (Time, position) |
| | | information |

Table 6 shows C.2 Channel position descriptors, which are descriptors of the Channel position data included in the Sound Channel descriptors.

TABLE 6
C.2 Channel position descriptors

| Name of | Subject of | |
|---|---|---|
| Descriptor | Description | Example(s) |
| Allocation | Allocation | 1: first channel |
| number | number | |
| Spatial | Azimuth | 000: center of screen, |
| position | angle | 060: 60-degrees |
| data | Elevation | 000: position of listener's ear |
| | angle | height, 060: 60-degrees |
| Distance | distance | 3: 3 meter |
| position | | |
| data | | |
| Tolerance | horizontal | 10: ±10 degrees, 15: ±15 degrees |
| of Spatial | tolerance | |
| position | vertical | 10: ±10 degrees, 15: ±15 degrees |
| | tolerance | |
| | Moving | Information for moving |
| | Information | objects: especially Time |
| | of time | information |
| Tolerance | distance | 3: 3 meter |
| of Distance | Moving | Information for moving |
| position | Information | objects: especially Position |
| | of position | information |
| Type | Nominal | Full: general channel, LFE: |
| (Character- | frequency | Low frequency effect channel |
| istics) | Range | |
| of channel | Type of | /Direct/Diffuse/Surround |
| component | channel | |
| object | component | |
| | directivity | |

We extend the Basic sound field descriptor, which is the description method for the “sound signals to compose a single-layered sound field” as mentioned above, to the Extended sound field descriptor, which is the description method for the “sound signals to compose a multi-layered sound field.”

Table 7 illustrates terms and definitions of the Extended sound field descriptor.

TABLE 7
Terms

| | |
|---|---|
| Sound Essence | The sound resources that make up a |
| | sound program of television and |
| | sound-only program. |
| Group of sound | A group of one or more Sound field |
| field configurations | configurations which are meant to be |
| (Sound space | transmitted simultaneously. A group of |
| configurations) | Sound-field configurations which are |
| | intended to be (possibly) reproduced |
| | simultaneously through a defined |
| | Layered-Sound-field configuration. |
| | Example: Sound field of dialogue + |
| | Sound field of SE |
| Sound-field | The acoustical space within which the |
| | intended sound image is created, |
| | which is created by simultaneously |
| | reproducing sound channels described |
| | by the Group of sound field |
| | configurations. |
| Sound-field | Defined arrangement or configuration |
| configuration | of loudspeakers that conveys the |
| | intended Sound-field. (A group of |
| | sound channels that are intended to be |
| | reproduced simultaneously through a |
| | defined Sound-field Configuration). |
| Sound field of | Sound field consisting of Spatial |
| Spatial anchor (SE) | anchor (SE) element/Indicate of |
| | Spatial anchor (SE) Sound field. |
| Sound field of Dialogue | Sound field consisting of Dialogue |
| | element/Indicate of Dialogue Sound |
| | field. |
| Sound field of | Sound field of television program and |
| Video linked objects | the Sound field linked to Video signals. |
| Sound Channel | Distinct collection of sequenced sound |
| | samples that are intended for delivery |
| | to a single loudspeaker or other |
| | reproduction equipments. |
| | Composed of individual sound channel |
| | positions (directions) to be |
| | reproduced. Includes Type of Sound |
| | Channel Component Object |
| | (reproduction frequency level |
| | characteristics and spatial directivity |
| | characteristics). Includes an |
| | object-based signal. |

The Sound Essence descriptor includes the descriptor of the program, the descriptor (name) of the Sound-field, and the other relevant descriptors.

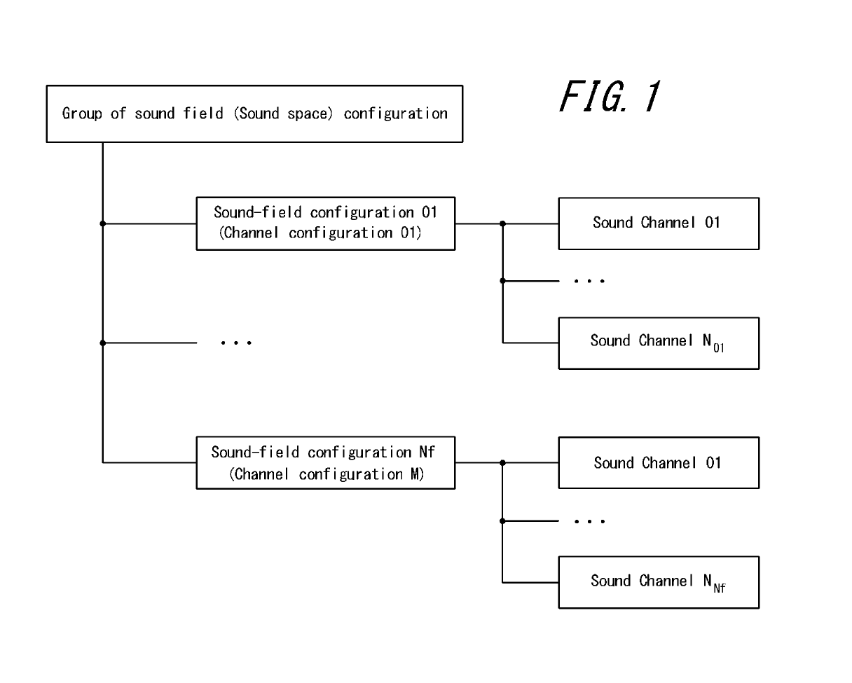

As shown in FIG. 1, the Sound-field in the Extended sound field descriptor is described by multiple Sound-field configurations (Group of sound-field configurations) (Sound space configurations) each having the hierarchical structure.

The Sound Channel descriptor includes the Channel label descriptor and/or the Channel Position descriptor.

Table 8 shows (A) Sound Essence descriptors in the Extended sound field descriptor.

TABLE 8
(A) Sound Essence descriptors (incl. Sound field)

| Name of | Subject of | |
|---|---|---|
| Descriptor | Description | Example(s) |
| Program name | Program name | Programme Title, |
| The number of | The total number | 2 |
| Sound-field | of Sound-field | |
| layers | layers | |
| List of | List of | complete mix, international mix, |
| Sound-field | Sound-field | spatial anchor, dialogue, |
| layers and | layers and | commentary, music, sound |
| Sound-field | Sound-field | effects, hearing impaired, visual |
| layer Type | layer Type | impaired, video linked objects, |
| | | [Samples] 01 spatial anchor, 02 |
| | | video linked objects, 03 |
| | | dialogue |

Table 9 shows A.2 Sound-field descriptors in the Extended sound field descriptor.

TABLE 9
A.2 Sound-field descriptors (each layer)

| Name of | Subject of | |
|---|---|---|
| Descriptor | Description | Example(s) |
| Sequential | Sequential | 1 |
| number of | number | |
| Sound-field | | |
| Type of | Name of | complete mix, international |
| Sound-field | Type and | mix, spatial anchor, dialogue, |
| layer | Content of | commentary, music, sound ef- |
| | Sound-field | fects, hearing impaired, visual |
| | | impaired, video linked objects |
| Video link | Linked/un- | linked |
| indicator | linked | |
| Description | Type of video | without video, SD, HD, |
| of video | format | UHDTV(4k), UHDTV(8k) |
| format/viewing | video viewing | horizontal viewing angle |
| angle | angle | (degree) 100° |
| Name of | Name of defined | 22.2 ch, 10.2 ch, etc. |
| Sound field | multichannel | |
| configuration | sound | |
| | arrangement or | |
| | configuration | |
| Language | Language | Korean, Japanese, Null, |

Regarding (B) Sound-field configuration descriptors and (C) Sound Channel descriptors in the Extended sound field descriptor, these descriptors are the same as those of the Basic sound field descriptor, and a description thereof is omitted.

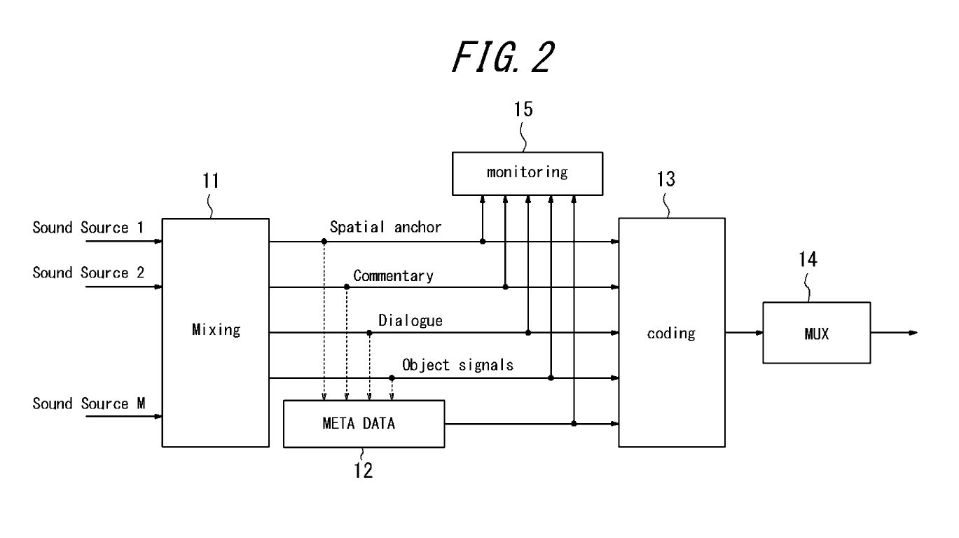

FIG. 2 shows a block diagram of a sound signal production equipment according to one of the embodiments. In order to “facilitate” rendering, conversion, and switching of received sound signals according to the receiver's environment or demand of program exchange or the home reproduction, the sound signal production equipment produces a sound program according to the Extended sound field descriptor, which is the format of the “sound signals to compose a multi-layered sound field.” The sound signal production equipment inserts the Extended sound field descriptor as metadata into the header of the corresponding sound format signal or into the header of each audio signal, for program exchange and transmission to the home. The sound signal production equipment includes a mixing unit 11, a metadata addition unit 12, a coding unit 13, a multiplexer 14, and a monitoring unit 15.

The mixing unit 11 mixes sound signals (Sound Sources 1-M) and outputs, to the coding unit 13, sound signals to compose the multi-layered sound field including Spatial anchor, Commentary, Dialogue, and Object signals, the sound signals being output from a “production system for sound signals to compose a multi-layered sound field.”

The metadata addition unit 12 outputs, to the coding unit 13, the metadata to be described for the Extended sound field descriptor of the multi-layered sound field including Spatial anchor, Commentary, Dialogue, and Object signals. The metadata addition unit 12 also outputs the produced metadata to the coding unit 13.

Based on the mixed sound signals received from the mixing unit 11 and the metadata received from the metadata addition unit 12, the coding unit 13 produces the sound signals according to the Extended sound field descriptor, encodes the produced sound signals, and outputs the encoded sound signals to the multiplexer 14.

The multiplexer 14 receives, from the coding unit 13, the sound signals according to the Extended sound field descriptor that have been encoded, and multiplexes the received sound signals into a bit stream, in order to convey a multiplexed sound signal to a sound signal reproduction equipment via broadcast or transmission. The multiplexer 14 transmits the multiplexed bit stream to remote places such as home via radio waves, IP circuits, and the like.

The monitoring unit 15 is used for checking contents of the sound signals and the metadata.

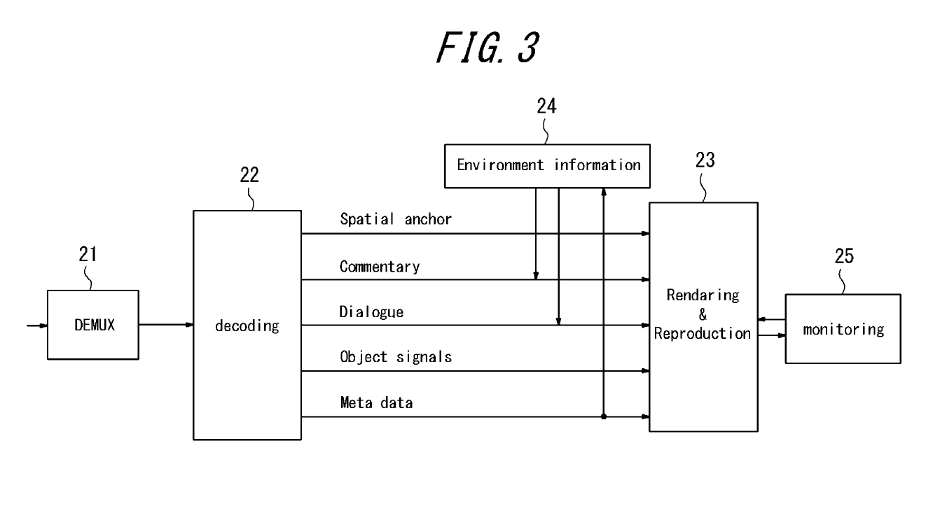

FIG. 3 shows a block diagram of the sound signal reproduction equipment according to one of the embodiments. In accordance with an input of information about a reproduction system, such as speaker arrangement information and user demand of narration sound position to be reproduced, the sound signal reproduction equipment utilizes the metadata included in the received sound signal and reproduces the received sound signal by controlling narration sound to be adjusted to a narration language and narration reproduction position desired by a user, while maintaining high quality sound providing as much of a sense of presence as was produced. Furthermore, in a reproduction environment with a video display having a different size from a size according to production conditions, the sound signal reproduction equipment controls a sound image field position in the sound field layer of a “video/sound linked sound source”, which requires a link between video and sound image positions, to be adjusted to the video display, and reproduces sound appropriately for reproduction environment with the video display, while maintaining the high quality sound providing as much of the sense of presence as was produced. The sound signal reproduction equipment includes a demultiplexer 21, a decoding unit 22, a rendering reproduction unit 23, an environment information input unit 24, and monitoring unit 25.

The demultiplexer 21 receives, via broadcast or transmission, the sound signal according to the Extended sound field descriptor that has been multiplexed into the bit stream, and demultiplexes the received sound signal into the respective sound signals of the sound field layers and the metadata. The demultiplexer 21 also outputs the demultiplexed sound signals and metadata to the decoding unit 22.

The decoding unit 22 decodes the encoded sound signals and metadata received from the demultiplexer 21 and outputs, to the rendering reproduction unit 23, signals including Spatial anchor, Commentary, Dialogue, Object signals, and metadata.

Based on the Extended sound field descriptor, the rendering reproduction unit 23 reproduces the original sound signals as they are, or renders (e.g. down-mixes) the sound signals based on the reproduction environment (e.g. the number of channels of a speaker and a display size) before reproducing the sound signals. That is to say, the rendering reproduction unit 23 renders (e.g switches, converts, and renders) the sound signals based on the Extended sound field descriptor in a sound reproduction environment different from the environment during program production.

The environment information input unit 24 displays to a user the metadata information described as the Extended sound field descriptor, receives user inputs about the reproduction environment information and user demand information, namely, language selection for the multiplexed sound, reproduction environment information (e.g. the speaker configuration and the display size), and the like, and outputs the reproduction environment information and user demand information to the rendering reproduction unit 23.

The monitoring unit 25 is used for checking a result of reproduction performed by the rendering reproduction unit 23, as well as program viewing.

The following describes specific usage embodiments of the sound signal production equipment and the sound signal reproduction equipment. For example, the disclosed sound signal production equipment and the disclosed sound signal reproduction equipment make it possible to easily control the narration language switching and narration reproduction position relocation in accordance with the home reproduction environment and user demand. Furthermore, in the reproduction environment with the video display having the different size than the size according to production conditions, the disclosed sound signal production equipment and the disclosed sound signal reproduction equipment make it possible to easily control the sound image field position in the sound field layer of the “video/sound linked sound source”, which requires the video to be linked to the sound image position, to be adjusted to the video display and perform reproduction, while maintaining the high quality sound providing as much of the sense of presence as was produced.

### Production Embodiment 1

### Production of Signal Including Sound Field Layer Associated with Multiple Languages

As an example of program production using the Extended sound field descriptor, i.e., the format of the “sound signals to compose a multi-layered sound field”, suppose a case where not only the sound signals of the Japanese or Korean narrations and dialogues but also the sound signals of various languages such as English are produced. In the above example, the sound signal production system is formed by the format of the “sound signals to compose a multi-layered sound field” including the sound field layer of the international sound (Spatial anchor) used irrespective of language, and the sound field layers (Commentary, Dialogue) of the narrations and dialogues of particular languages.

In this example, the metadata addition unit 12 adds the metadata shown in Table 10 to the header of the corresponding multichannel-sound-format signal or to the headers on each sound channel constituting the multichannel according to the Extended sound field descriptor.

TABLE 10

| Name | Function |
|---|---|
| The number of layers | Indicates how many sound field layers |
| of sound field | are included. |
| (A: The number of | |
| Sound-field layers) | |
| Sound field layer type | Indicates the type of each sound field |
| (A.2: Type of Sound-filed) | layer, such as international sound and |
| | dialogue. |
| Language information | Indicates the languages of dialogue |
| (A.2: Language) | and narration sound field layers. |

### Reproduction Embodiment 1

### Reproduction of Signal Including Sound Field Layer Associated with Multiple Languages

The user inputs the information of the reproduction system, such as the speaker arrangement information and the user demand of narration sound position to be reproduced, and controls the sound signals (e.g. the user arbitrarily adjusts the reproduction position). For example, in the home reproduction environment the sound signals can be reproduced under control in terms of a desired narration language and narration reproduction position while the high quality sound providing as much of the sense of presence as was produced is maintained.

In order to achieve the above function, the user at an receiving side inputs, through the environment information input unit 24, the information of desired narration sound (e.g. the narration language that the user demands to reproduce and the narration reproduction position) and the information of the reproduction system (e.g. speaker arrangement information). The rendering reproduction unit 23 switches a sound signal of the “narration language” layer that has been designated from among the produced narration languages described in the metadata, adds to the switched sound signal the international sound used irrespective of language for reproduction, and reproduces the sound signal. The rendering reproduction unit 23 is also fed the desired narration reproduction position, the speaker arrangement information, and the sound signal of the produced “narration language” layer. The rendering reproduction unit 23 also relocates the switched sound signal so that reproduction is performed from the designated narration reproduction position and renders the signal so that the sound quality providing as much of the sense of presence as was produced is achieved. Subsequently, the rendering reproduction unit 23 adds, to the rendered signal, the international sound used irrespective of language and reproduces the signal.

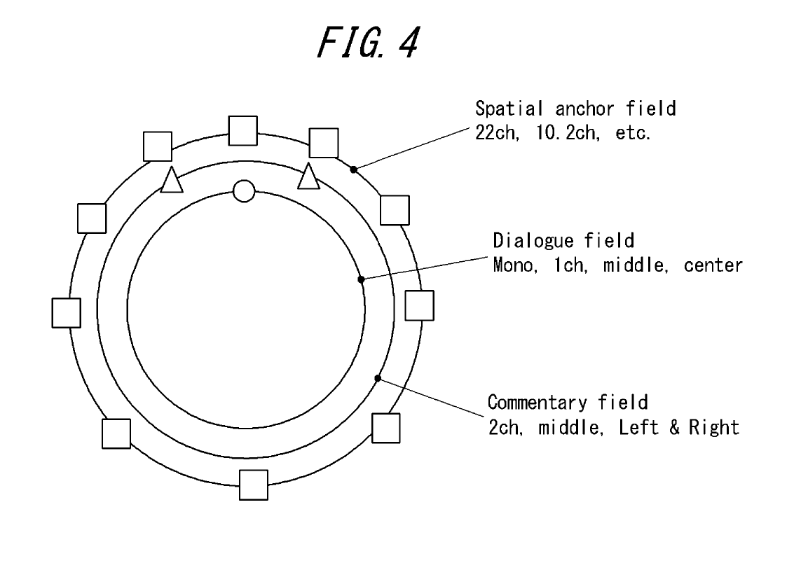

FIG. 4 is a conceptual diagram of the multi-layered sound field including the sound field layer of the international sound (Spatial anchor) used irrespective of language, and the sound field layers of the “narration languages” (Commentary, Dialogue).

### Production Embodiment 2

### Production of Program Including Sound Field Layer Associated with Linked/Unlinked Video and Sound

As an example of program production using the Extended sound field descriptor, i.e., the format of the “sound signals to compose a multi-layered sound field”, suppose a case where the “sound requiring the link between video and sound positions” and the “sound directly irrespective of the video position” are separately produced and recorded. Sound signals include not only the “sound requiring the link between video and sound positions” (e.g. the dialogue of an actor and sound emitted from an object on the screen) but also the “sound directly irrespective of the video position” (e.g. sound effects for enhancing the sense of presence of an entire program), and the “sound requiring the link between video and sound positions” and the “sound directly irrespective of the video position” can be separately produced and recorded. In the above example, the sound signal production system is formed by the format of the “sound signals to compose a multi-layered sound field” including the sound field layer of the “sound requiring the link between video and sound positions” and the “sound directly irrespective of the video position.”

In this example, the metadata addition unit 12 adds the metadata shown in Table 11 to the header of the corresponding multichannel sound format signal or to the headers on each sound channel constituting the multichannel according to the Extended sound field descriptor.

TABLE 11

| Name | Function |
|---|---|
| The number of layers | Indicates how many sound field |
| of sound field | layers are included. |
| (A: The number of | |
| Sound-field layers) | |
| Video Link Identifier | Indicates whether or not the sound |
| (A.2: Video link indicator) | field layer is linked to video. |
| Video format/viewing angle | Indicates the type of video format and |
| (A.2: Description of video | an optimal viewing angle in the sound |
| format/viewing angle) | field linked to video. |

### Reproduction Embodiment 2

### Reproduction of Program Including Sound Field Layer Associated with Linked/Unlinked Video and Sound

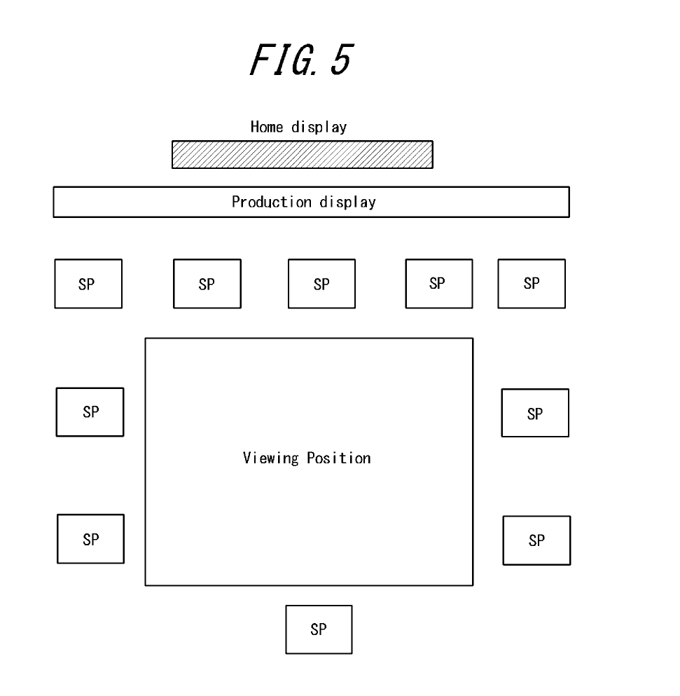

In the reproduction environment with the video display having the different size than the size according to the production conditions as shown in FIG. 5, for example, the sound signal reproduction equipment controls the sound image field position in the sound field layer of the “video/sound linked sound source”, which requires the link between video and sound image positions, to be adjusted to the video display and reproduces sound, while maintaining the high quality sound providing as much of the sense of presence as was produced.

In order to achieve the above function, the user at the receiving side inputs, through the environment information input unit 24, the information of the reproduction system (e.g. speaker arrangement and video display information). When the conditions for the video display and the speaker arrangement during production are the same as the conditions for the video display and the speaker arrangement at the receiving side, the rendering reproduction unit 23 does neither convert nor render the received sound signals. In this case, the rendering reproduction unit 23 adds the “sound requiring the link between video and sound positions” and the “sound directly irrespective of the video position” and reproduces the added sound. On the other hand, when the above conditions are not the same in terms of either one of the video display and the speaker arrangement, the rendering reproduction unit 23 converts the received sound signals by either rendering or down-mixing so that the sound quality providing as much of the sense of presence as was produced is achieved, and reproduces the added sound signals. When the video display size is different, and the speaker arrangement is the same, the rendering reproduction unit 23 renders the sound signals of the layer of the “sound preferably requiring the link between video and sound positions” so that a width of the video display size equals a width of the sound image. The rendering reproduction unit 23 adds the rendered “sound preferably requiring the link between video and sound positions” and the unconverted and un-rendered “sound directly irrespective of the video position” and reproduces the added sound. Here, the rendering processing, i.e., processing for equalizing the width between the sound image of the “sound preferably requiring the link between video and sound positions” and the video display size, can be easily performed by using field position information of Azimuth angle and Elevation angle included in Spatial position data defined in Channel position data.

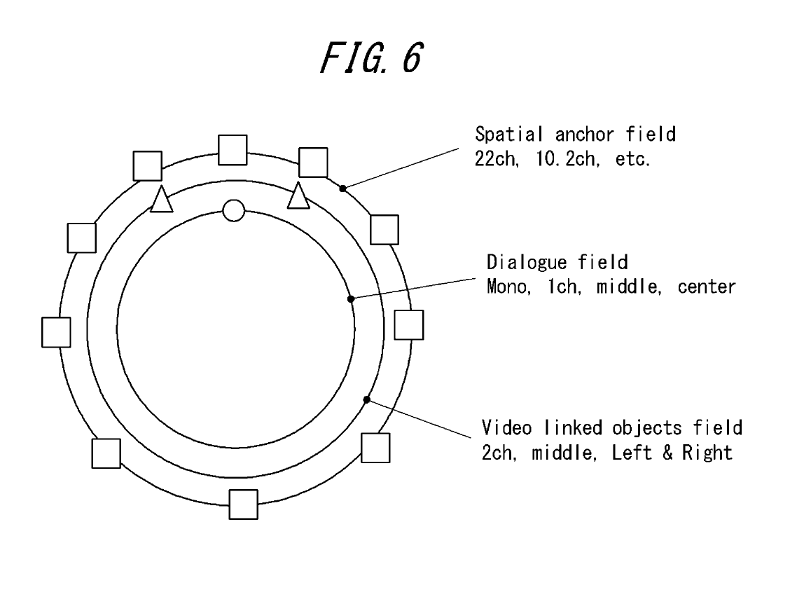

FIG. 6 is a conceptual diagram of the multi-layered sound field including the sound field layer of “video/sound linked sound source” (Video linked object) and the sound field layers “directly irrespective of the video position” (Spatial anchor, Dialogue).

Thus, according to the above embodiment, the Extended sound field descriptor includes the number of sound field layers, the type of each sound field layer, and the language information. With the above structure, the sound signal description method corresponding to the format of the “sound signals to compose a multi-layered sound field” is achieved.

Furthermore, it is preferable that the type of each sound field layer indicates which one of international sound and a particular language the sound field layer comprises, the international sound being used irrespective of language. With the above structure, in the home reproduction environment, for example, the sound signals can be reproduced under control in terms of the desired narration language and narration reproduction position while the high quality sound providing as much of the sense of presence as was produced is maintained.

Moreover, according to the above embodiment, the Extended sound field descriptor includes the number of multiple sound field layers and a video link identifier indicating, for each sound field layer, whether the sound field layer is linked to video. With the above structure, in the reproduction environment with the video display having the different size than the size according to the production conditions, for example, the sound image field position in the sound field layer of the “video/sound linked sound source”, which requires the link between video and sound image positions, can be controlled to be adjusted to the video display, and reproduction is performed, while the high quality sound providing as much of the sense of presence as was produced is maintained.

Moreover, with the sound signal production equipment and the sound signal reproduction equipment according to the above embodiments, the sound signal described by the Extended sound field descriptor can be produced and reproduced. Note that the disclosed equipment also includes, in its scope, any equipment that transmits the sound signal described by the Extended sound field descriptor to the remote places such as home via radio waves, IP circuits, and the like, any equipment that stores and records in a recording medium the sound signal described by the Extended sound field descriptor, and a recording medium in which the sound signal described by the Extended sound field descriptor is stored and recorded.

The sound signal production equipment according to one of the embodiments produces the metadata including the number of sound field layers, the type of each sound field layer, and the language information, produces the sound signal according to the Extended sound field descriptor based on an input sound signal and the metadata, and multiplexes the sound signal into the bit stream. Furthermore, the sound signal reproduction equipment according to one of the embodiments converts the sound signal according to the number of sound field layers, the type of each sound field layer, and the language information included in the sound signal and according to the reproduction environment information and user demand information, and reproduces the converted sound signal. The above structure makes it possible to produce and view a program using the “sound signals to compose a multi-layered sound field.” In particular, the sound signal reproduction equipment adds, to the international sound, the sound signal of the particular language that has been switched by the user, and reproduces the added sound. The above structure allows the user to arbitrarily carry out an operation such as language selection with use of the received metadata, thereby making it possible to switch and relocate the appropriate narration language and narration reproduction position, while the high quality sound providing as much of the sense of presence as was produced is maintained.

Moreover, the sound signal production equipment according to one of the embodiments produces the metadata including the number of layers of sound field and a video link identifier indicating, for each sound field layer, whether the sound field layer is linked to video, produces the sound signal according to the Extended sound field descriptor based on the input sound signal and the metadata, and multiplexes the sound signal into the bit stream. Moreover, the sound signal reproduction equipment according to one of the embodiments converts the sound signal according to the video link identifier and according to the reproduction environment information of the user, the video link identifier indicating, for each sound field layer, whether the sound field layer is linked to video, and the sound signal reproduction equipment reproduces the converted sound signal. The above structure makes it possible to produce and view the program using the “sound signals to compose a multi-layered sound field.” In particular, when the video link identifier indicates that the sound field layer is linked to video, the rendering reproduction unit renders the sound signal of the sound field layer based on information about the video display of the user, and reproduces the rendered sound signal. The above structure makes it possible to render and convert the sound image field position in the sound field layer of the “video/sound linked sound source”, which requires the link between video and sound image positions, so that the sound field image position is adjusted to the video display, while the high quality sound providing as much of the sense of presence as was produced is maintained by inputting the information of the reproduction system (e.g. the video display) of the user and by using the information of the video display during production described in the metadata.

While our methods and equipment have been described based on the drawings and embodiments, it should be noted that a person skilled in the art can readily make various modifications and changes in accordance with the disclosure. As such, it should also be noted that the modifications and changes are within the scope of the disclosure. For example, the function or the like included in each element, each means, and each step is subject to rearrangement, and several means and steps can be combined into a single means or step or they can be divided.

### INDUSTRIAL APPLICABILITY

We make it possible to describe a “sound signals to compose a multi-layered sound field”, and to produce and view/listen a program using such sound signals. As a result, interoperability between different next generation sound systems is achieved, and even in a sound reproduction environment different from the environment during program production, switching, conversion, and rendering of the sound signals is facilitated.

### REFERENCE SIGNS LIST

11 mixing unit
12 metadata addition unit
13 coding unit
14 multiplexer
15 monitoring unit
21 demultiplexer
22 decoding unit
23 rendering reproduction unit
24 environment information input unit
25 monitoring unit

1. A sound signal description method for describing a multi-layered sound field, comprising:
the number of sound field layers of the multi-layered sound field;
a type of each sound field layer of the multi-layered sound field; and
language information.

2. The sound signal description method recited in claim 1, wherein the type of each sound field layer of the multi-layered sound field indicates which one of international sound and a particular language the sound field layer comprises, the international sound being used irrespective of language.

3. A sound signal description method for describing a multi-layered sound field, comprising:
the number of sound field layers of the multi-layered sound field; and
a video link identifier indicating, for each sound field layer of the multi-layered sound field, whether the sound field layer is linked to video.

4. A sound signal production equipment that produces a sound signal according to a sound signal description method for describing a multi-layered sound field, comprising:
a metadata addition unit that produces metadata including the number of sound field layers of the multi-layered sound field, a type of each sound field layer of the multi-layered sound field, and language information;
a coding unit that produces the sound signal according to the sound signal description method based on an input sound signal and the metadata; and
a multiplexer that multiplexes the produced sound signal into a bit stream.

5. A sound signal reproduction equipment that reproduces a sound signal according to a sound signal description method for describing a multi-layered sound field, comprising:
an environment information input unit that inputs reproduction environment information and user demand information; and
a rendering reproduction unit that converts the sound signal according to the number of sound field layers of the multi-layered sound field, a type of each sound field layer of the multi-layered sound field, and language information included in the sound signal and according to the reproduction environment information and user demand information, and reproduces the converted sound signal.

6. The sound signal reproduction equipment recited in claim 5, wherein
the type of each sound field layer of the multi-layered sound field indicates which one of international sound and a particular language the sound field layer comprises, the international sound being used irrespective of language, and the particular language being switched by the environment information input unit, and
the rendering reproduction unit adds the sound signal of the particular language to the international sound and reproduces added sound.

7. A sound signal production equipment that produces a sound signal according to a sound signal description method for describing a multi-layered sound field, comprising:
a metadata addition unit that produces metadata including the number of sound field layers of the multi-layered sound field and a video link identifier indicating, for each sound field layer of the multi-layered sound field, whether the sound field layer is linked to video;
a coding unit that produces the sound signal according to the sound signal description method based on an input sound signal and the metadata; and
a multiplexer that multiplexes the produced sound signal into a bit stream.

8. A sound signal reproduction equipment that reproduces a sound signal according to a sound signal description method for describing a multi-layered sound field, comprising:
an environment information input unit that inputs reproduction environment information and user demand information; and
a rendering reproduction unit that converts the sound signal according to the number of sound field layers of the multi-layered sound field and a video link identifier included in the sound signal and according to the reproduction environment information and user demand information, the video link identifier indicating, for each sound field layer of the multi-layered sound field, whether the sound field layer is linked to video.

9. The sound signal reproduction equipment recited in claim 8, wherein
when the video link identifier indicates that the sound field layer is linked to video, the rendering reproduction unit renders the sound signal of the sound field layer based on video display information input by the environment information input unit.
